(19) United States
(12) Patent Application Publication
(10) Pub. No.: US 2011/0249034 A1
(43) Pub. Date: Oct. 13, 2011

(54) Luminance Control Apparatus and Luminance Control Method

(76) Inventor: Kenichi Nagai, Isesaki-shi (JP)

(21) Appl. No.: 12/985,806

(22) Filed: Jan. 6, 2011

(30) Foreign Application Priority Data
Apr. 13, 2010 (JP) 2010-092589

(51) Int. Cl. G09G 5/10

(52) U.S. Cl. 345/690

(57) ABSTRACT

According to one embodiment, a light source luminance control apparatus includes a generator and a luminance controller. A light source block formed of one or more light sources corresponds to a divided display area. An image display area formed of a plurality of divided display areas corresponds to a plurality of light source blocks. The generator is configured to generate a first luminance control signal to perform whole control of luminances of the light sources corresponding to the image display area, in accordance with an image signal. The generator is configured to generate a second luminance control signal to perform divided control of luminance of each light source for each of the light source blocks, in accordance with the image signal. The luminance controller is configured to control the luminances of the light sources, based on the first and the second luminance control signals.

### CROSS-REFERENCE TO RELATED APPLICATIONS

This application is based upon and claims the benefit of priority from Japanese Patent Application No. 2010-092589, filed Apr. 13, 2010; the entire contents of which are incorporated herein by reference.

### FIELD

Embodiments described herein relate generally to a backlight luminance control technique.

### BACKGROUND

Liquid crystal displays such as digital televisions are configured such that a backlight which is disposed on, for example, the back surface of the liquid crystal panel illuminates the liquid crystal. The backlight uses a CCFL fluorescent tube or a plurality of light emitting diode (LED) lights as a light source. In a backlight using LEDs as a light source, area luminance control is known. In area luminance control, the luminances of the LED lights forming the backlight are controlled for each group of a predetermined number of LED lights. For example, a technique disclosed in Jpn. Pat. Appln. KOKAI Pub. No. 2009-204825 is known.

Whole luminance control in which luminance of a plurality of LED lights which form the backlight is uniformly controlled according to an image signal is also well known. In addition, area luminance control in which luminance of LED lights which form the backlight is controlled for each group of a predetermined number of LED lights is also well known.

Although area luminance control is expected to realize high image quality and low electric power consumption in comparison with whole luminance control, there are cases where area luminance control is not suitable, and improvement in luminance control is desired.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram illustrating an example of an image display apparatus according to first to fourth embodiments.

FIG. 2 is a diagram illustrating an example of relation between a plurality of light source blocks forming a backlight and a plurality of divided display areas corresponding to a liquid crystal panel (image display area).

FIG. 3 is a diagram illustrating an example of area luminance control according to an input image signal.

FIG. 4A is a diagram illustrating an example of a white ball image moving in a dark background.

FIG. 4B is a diagram illustrating an example of area luminance control performed in accordance with the white ball image illustrated in FIG. 4A.

FIG. 4C is a diagram illustrating an example of a white ball image to which the area luminance control illustrated in FIG. 4B is applied.

FIG. 5 is a diagram illustrating an example of luminance control according to the first embodiment.

FIG. 6 is a diagram illustrating an example of luminance control according to the second embodiment.

FIG. 7 is a diagram illustrating an example of luminance control according to the third embodiment.

FIG. 8 is a diagram illustrating an example of luminance control according to the fourth embodiment.

### DETAILED DESCRIPTION

Various embodiments will be described hereinafter with reference to the accompanying drawings.

In general, according to one embodiment, a light source luminance control apparatus includes a generator and a luminance controller. A light source block formed of one or more light sources corresponds to a divided display area. An image display area formed of a plurality of divided display areas corresponds to a plurality of light source blocks. The generator is configured to generate a first luminance control signal to perform whole control of luminances of the light sources corresponding to the image display area, in accordance with an image signal. The generator is configured to generate a second luminance control signal to perform divided control of luminance of each light source for each of the light source blocks, in accordance with the image signal. The luminance controller is configured to control the luminances of the light sources, based on the first and the second luminance control signals.

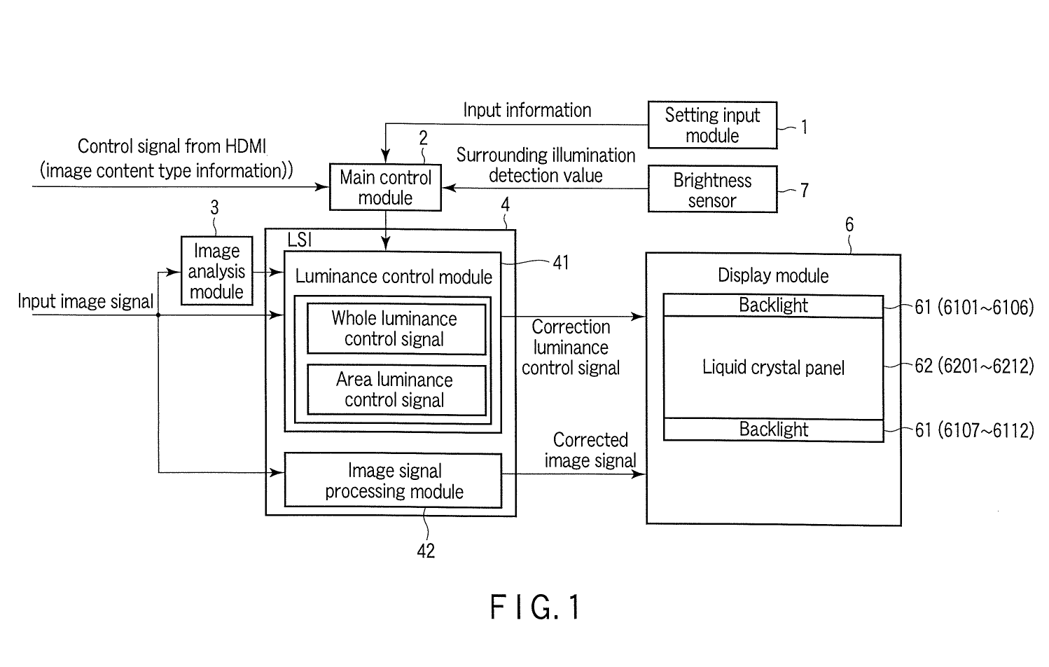

First to fourth embodiments will be described hereinafter with reference to the drawings. FIGS. 1 to 4 are diagrams common to the first to fourth embodiments.

FIG. 1 is a diagram illustrating an example of an image display apparatus. As illustrated in FIG. 1, the image display apparatus comprises a setting input module 1, a main control module 2, an image analysis module 3, a luminance control module 41, an image signal processing module 42, an image display module 6, and a brightness sensor 7. The image display module 6 includes a backlight 61 and a liquid crystal panel 62. The luminance control module 41 and the image signal processing module 42 may be formed of an LSI (Large Scale Integrated circuit) 4.

The setting input module 1 notifies the main control module 2 of, for example, input information from the user. The setting input module 1 may be, for example, a remote controller. The brightness sensor 7 detects a surrounding illumination, and notifies the main control module 2 of a surrounding illumination detection value.

The main control module 2 sets various conditions based on the input information from the setting input module 1. The main control module 2 also notifies the luminance control module 41 of the surrounding illumination detection value from the brightness sensor 7. The luminance control module 41 can control luminance of the backlight 61, based on the surrounding illumination detection value. In addition, the main control module 2 can detect the type of an input image signal inputted through an HDMI (High-Definition Multimedia Interface) based on a control signal inputted through the HDMI, and notify the luminance control module 41 of an input image type detection result. The luminance control module 41 can control the luminance of the backlight 61, based on the type detection result. Luminance control based on the surrounding illumination detection value and luminance control based on the type detection result will be explained in detail later.

The image analysis module 3 can analyze the input image signal, and detect whether the input image signal is movie content or not. For example, the image analysis module 3 can generate a density histogram based on the input image signal and detect, based on the density histogram, whether an image based on the input image signal includes black zones or not. The image analysis module 3 can determine the input image signal is movie content, based on detection of a black zone. As another example, the image analysis module 3 can detect the format of the input image signal, and detect whether the input image signal is movie content or not, based on the detected format. For example, the image analysis module 3 can determine that the input image signal is movie content, based on detection of a 2-3 pull-down format or a 24P format. The 2-3 pull-down format is a format in which an image recorded at 24 frames per second, such as movie films, is converted (pulled down) into an image signal at 30 frames (60 fields) per second. The 24P format is a format of progressive scan of 24 frames per second.

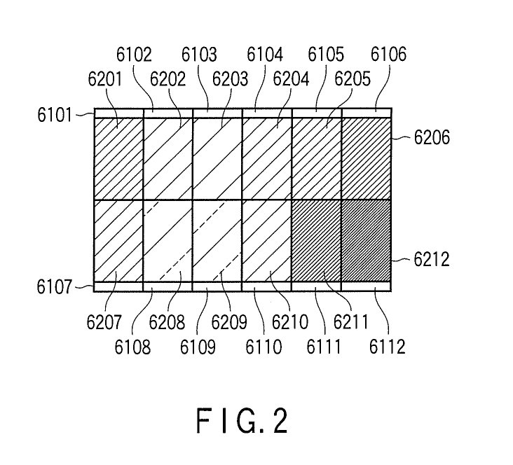

The image display module 6 includes the backlight 61 and the liquid crystal panel 62. FIG. 2 is a diagram illustrating an example of relation between a plurality of light source blocks 6101 to 6112 forming the backlight 61 and a plurality of divided display areas 6201 to 6212 corresponding to the liquid crystal panel 62 (image display area). Explained is the case of applying luminance controls of the first to fourth embodiments to the backlight 61 adopting a method called edge light method or side light method as illustrated in FIG. 2. Luminance controls of the first to fourth embodiments can also be applied to the backlight adopting, for example, direct method.

As illustrated in FIG. 2, the backlight 61 is formed of a plurality of light source blocks 6101 to 6112. Light source block 6101 is formed of one or more light sources (LED lights). Light source blocks 6102 to 6112 also have the same structure.

An image display area corresponding to the liquid crystal panel 62 is formed. The image display area is formed of a plurality of divided display areas 6201 to 6212.

Light emitted from one or more light sources forming light source block 6101 is made incident on a light guide board corresponding to divided display area 6201. The incident light repeats surface reflection in the light guide board to uniformly spread on the light guide board, and the light outgoing from the light guide board illuminates divided display area 6201. Specifically, the light emitted from one or more light sources forming light source block 6101 almost uniformly illuminates divided display area 6201. In the same manner, light beams emitted from one or more light sources forming light source blocks 6102 to 6112 almost uniformly illuminate divided display areas 6202 to 6212, respectively.

The luminance control module 41 can generate a whole luminance control signal (first luminance control signal) to control (global dimming control) luminances of the light sources corresponding to the image display area (divided display areas 6201 to 6212) all together, in accordance with the input image signal, and control luminances of the light sources all together based on the whole luminance control signal. For example, the luminance control module 41 calculates the black area ratio in a picture of the screen generated based on the input image signal, and generates a whole luminance control signal in accordance with the black area ratio. In other words, the luminance control module 41 generates a whole luminance control signal, based on average luminance calculated from the input image signal. The luminance control module 41 generates a whole luminance control signal to control the luminances of the light sources to low luminance when the black area ratio in a picture of the screen is high (when the average luminance is low), and generates a whole luminance control signal to control the luminances of the light sources to high luminance when the black area ratio in a picture of the screen is low (when the average luminance is high).

As another example, the luminance control module 41 can also generates a whole luminance control signal in accordance with the input image signal and the surrounding illumination detection value, and control the luminances of the light sources all together based on the whole luminance control signal. For example, the luminance control module 41 calculates the black area ratio in a picture of the screen generated based on the input image signal, and generates a whole luminance control signal in accordance with the black area ratio and the surrounding illumination detection value. In addition to luminance control in accordance with the black area ratio, the luminance control module 41 generates a whole luminance control signal to control the luminances of the light sources to low luminance when the surrounding illumination is low (when it is dark), and generates a whole luminance control signal to control the luminances of the light sources to high luminance when the surrounding illumination is high (when it is light).

As described above, the luminance control module 41 can control the luminances of the light sources all together, based on the whole luminance control signal. In other words, the luminance control module 41 can uniformly control the luminance of the image display area corresponding to the liquid crystal panel. The above method of controlling the luminances of the light sources all together is referred to as whole luminance control.

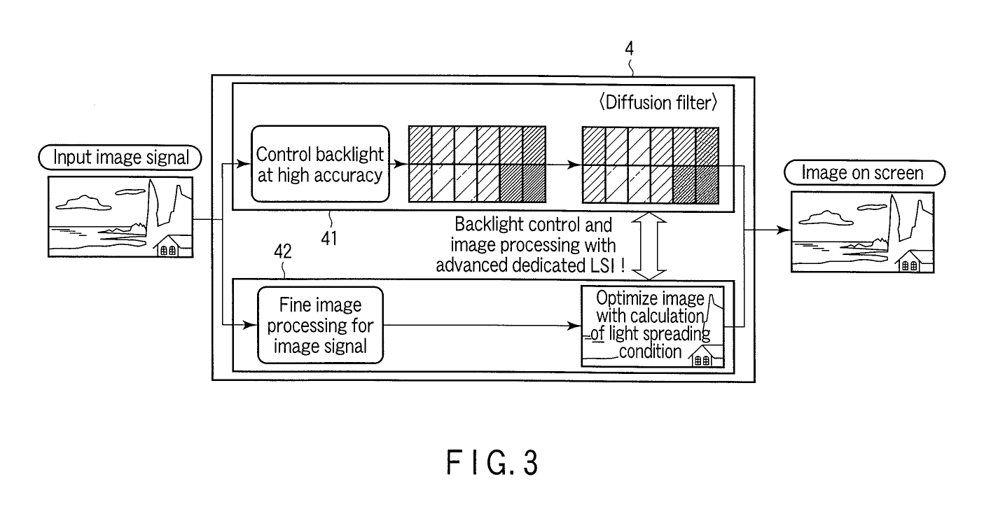

In addition, the luminance control module 41 can generate an area luminance control signal (second luminance control signal) to control luminances of the light sources separately for each light source block 6101 to 6112, and control luminances of the light sources separately for each light source block 6101 to 6112 based on the area luminance control signal (see FIG. 3). For example, the luminance control module 41 detects light parts and dark parts in a picture of the screen generated based on the input image signal, and generates an area luminance control signal in accordance with a light-part and dark-part detection result. In other words, the luminance control module 41 detects average luminance of a partial image displayed in each of divided display areas 6201 to 6212, and generates an area luminance control signal based on the average luminance of the partial image. Specifically, the luminance control module 41 generates an area luminance control signal to control luminances of the light sources of the divided display areas corresponding to light partial images to high luminance, and control luminances of the light sources of the divided display areas corresponding to dark partial images to low luminance.

As another example, the luminance control module 41 can generate an area luminance control signal in accordance with the input image signal and the surrounding illumination detection value, and control luminances of the light sources separately for each light source block 6101 to 6112 based on the area luminance control signal. For example, the luminance control module 41 detects light parts and dark parts in a picture of the screen generated based on the input image signal, and generates an area luminance control signal in accordance with a light-part and dark-part detection result and the surrounding illumination detection value. In addition to area luminance control in accordance with the light-part and dark-part detection result, the luminance control module 41 generates an area luminance control signal to control luminances of the light sources to high luminance when the surrounding illumination is low (when it is dark), and control luminances of the light sources to low luminance when the surrounding illumination is high (when it is light).

As described above, the luminance control module 41 can control luminances of the light sources separately for each light source block 6101 to 6112, based on the area luminance control signal. In other words, the luminance control module 41 can individually control the luminance of each of the divided display areas corresponding to the liquid crystal panel 62. The above method of controlling the luminances of the light sources for each light source block 6101 to 6112 is referred to as area luminance control. In addition, the diffusion filter 41 diffuses brightness of each of divided display areas 6202 to 6212, and smoothes difference in brightness between divided display areas 6202 to 6212 (see FIG. 3).

The luminance control module 41 can also control luminances of the light sources, using whole luminance control together with area luminance control simultaneously. Specifically, the luminance control module 41 can perform variable control of the percentage of whole luminance control from 0% to 100% in accordance with the situation (for example, in accordance with the characteristic of the input image signal), perform variable control of the percentage of area luminance control from 100% to 0% in accordance with the ratio of whole luminance control, generate a correction luminance control signal in accordance with the variable controls, and control the luminances of the light sources forming the backlight 61 based on the correction luminance control signal.

In addition, the luminance control module 41 can gradually change the ratio of whole luminance control to area luminance control in accordance with the situation, and set the ratio of whole luminance control to area luminance control to a target ratio. For example, when the percentage of whole luminance control is to be set to 60% and the percentage of area luminance control is to be set to 40%, the luminance control module 41 gradually changes the percentage of whole luminance control from 50% to 60%, and changes the percentage of area luminance control from 50% to 40% in accordance with change of the percentage of whole luminance control. As another example, the luminance control module 41 gradually changes the percentage of whole luminance control from 0% to 60%, and changes the percentage of area luminance control from 100% to 40% in accordance with change of the percentage of whole luminance control. As another example, the luminance control module 41 gradually changes the percentage of whole luminance control from 100% to 60%, and changes the percentage of area luminance control from 0% to 40% in accordance with change of the percentage of whole luminance control.

As described above, the luminance control module 41 can use whole luminance control simultaneously with area luminance control together, and use whole luminance control and area luminance control at different times. For example, the luminance control module 41 can control luminances of the light sources by whole luminance control or area luminance control in a first time period (first timing), and control luminances of the light sources by area luminance control or whole luminance control in a second time period (second timing). For example, the luminance control module 41 can control luminances of the light sources by whole luminance control in accordance with playback of movie content, and control luminances of the light sources by area luminance control in accordance with playback of content which is not a movie.

The image signal processing module 42 applies various processing to the input image signal, and corrects the input image signal based on, for example, a light spreading state obtained by the diffusion filter. The display module 6 displays an image based on the corrected image signal, by illumination of the backlight 61, luminance of which is controlled by the luminance control module 41.

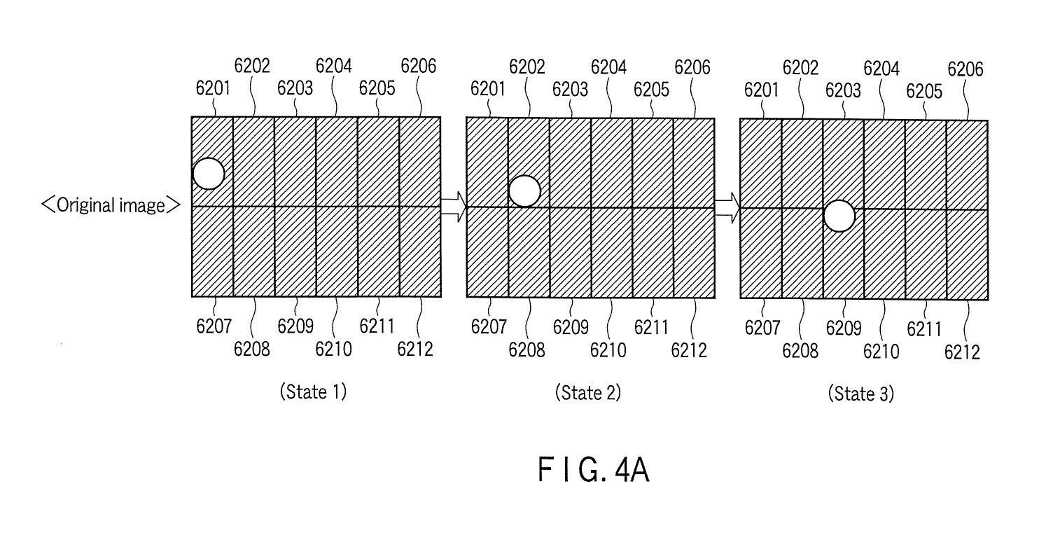

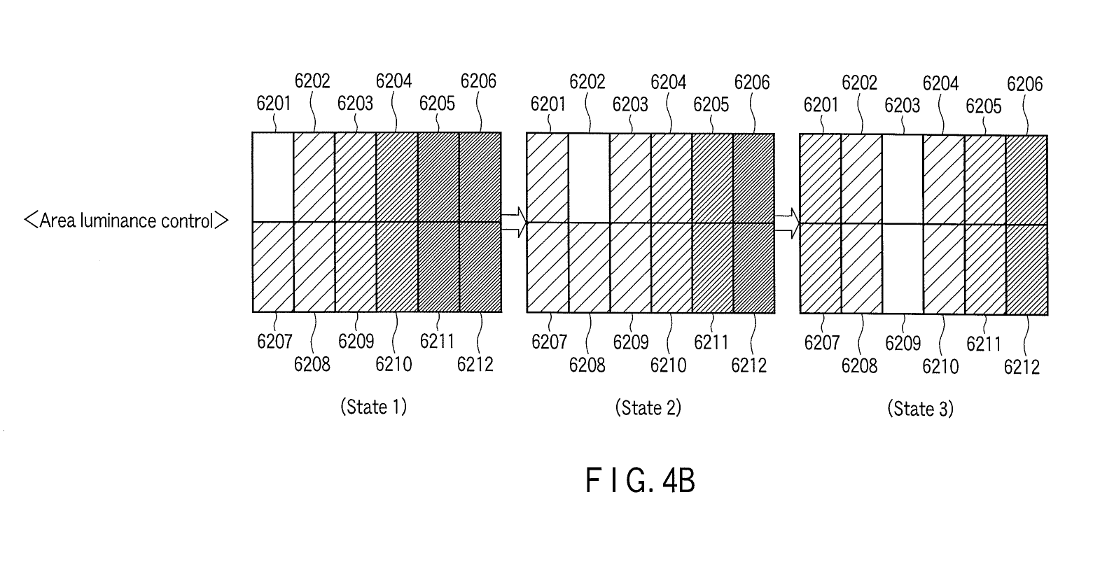

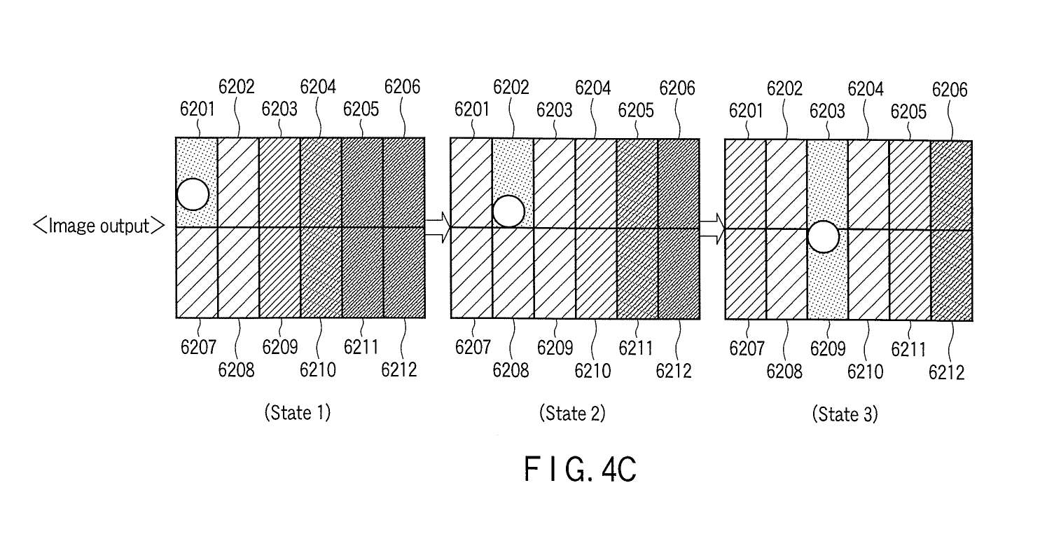

The area luminance control is expected to produce an electric power saving effect, according to the number of divisions and dividing patterns. On the other hand, there are cases where area luminance control is not suitable. FIG. 4A is a diagram illustrating an example of a white ball image moving in a dark background, FIG. 4B is a diagram illustrating an example of area luminance control corresponding to the white ball image illustrated in FIG. 4A, and FIG. 4C is a diagram illustrating an example of a white ball image obtained by applying area luminance control illustrated in FIG. 4B.

For example, in correspondence with a white ball illustrated in State 1 of FIG. 4A, a light source corresponding to divided display area 6201 is controlled to have a first luminance (high luminance) as illustrated in State 1 of FIG. 4B, light sources corresponding to divided display areas 6202, 6207, and 6208 are controlled to have a second luminance lower than the first luminance, light sources corresponding to divided display areas 6203 and 6209 are controlled to have a third luminance'lower than the second luminance, light sources corresponding to divided display areas 6204 and 6210 are controlled to have a fourth luminance lower than the third luminance, and light sources corresponding to divided display areas 6205, 6206, 6211, and 6212 are controlled to have a fifth luminance lower than the fourth luminance. As a result, image display as illustrated in State 1 of FIG. 4C is outputted.

Next, in correspondence with the white ball illustrated in State 2 of FIG. 4A, the light source corresponding to divided display area 6202 is controlled to have the first luminance (high luminance) as illustrated in State 2 of FIG. 4B, the light sources corresponding to divided display areas 6201, 6203, 6207, 6208, and 6209 are controlled to have the second luminance lower than the first luminance, the light sources corresponding to divided display areas 6204 and 6210 are controlled to have the third luminance lower than the second luminance, the light sources corresponding to divided display areas 6205 and 6211 are controlled to have the fourth luminance lower than the third luminance, and the light sources corresponding to divided display areas 6206 and 6212 are controlled to have the fifth luminance lower than the fourth luminance. As a result, image display as illustrated in State 2 of FIG. 4C is outputted.

Next, in correspondence with the white ball illustrated in State 3 of FIG. 4A, the light sources corresponding to divided display areas 6203 and 6209 are controlled to have the first luminance (high luminance) as illustrated in State 3 of FIG. 4B, the light sources corresponding to divided display areas 6202, 6204, 6208, and 6210 are controlled to have the second luminance lower than the first luminance, the light sources corresponding to divided display areas 6201, 6205, 6207, and 6211 are controlled to have the third luminance lower than the second luminance, and the light sources corresponding to divided display areas 6206 and 6212 are controlled to have the fourth luminance lower than the third luminance. As a result, image display as illustrated in State 3 of FIG. 4C is outputted.

As described above, the light sources corresponding to the divided display areas including the white ball are controlled to have high luminance, and the light sources corresponding to the divided display areas which are adjacent to the divided display areas including the white ball are controlled to have relatively high luminance. On the other hand, the light sources corresponding to the divided display areas distant from the white ball are controlled to have low luminance.

For example, supposing that the above image in which a white ball is moving is a scene of movie content and black zones are inserted into upper and lower parts of the image corresponding to the movie content, there are cases where luminance of the black zones is not uniform by the above area luminance control. For example, when the upper black zone is displayed over divided display areas 6201 to 6206 and the lower black zone is displayed over divided display areas 6207 to 6212, luminance of the black zones undesirably change in accordance with movement of the white ball. Specifically, part of the black zones displayed in the divided display areas including the white ball brightens, and part of the black zones displayed in the divided display areas distant from the white ball becomes dark. There are cases where brightness of the black zones which does not change in the image undesirably changes as described above by influence of area luminance control performed in accordance with movement of the white ball, and the image becomes unnatural.

Backlight luminance controls shown in the first to fourth embodiments explained hereinafter can reduce the above malfunction that the image becomes unnatural.

### First Embodiment

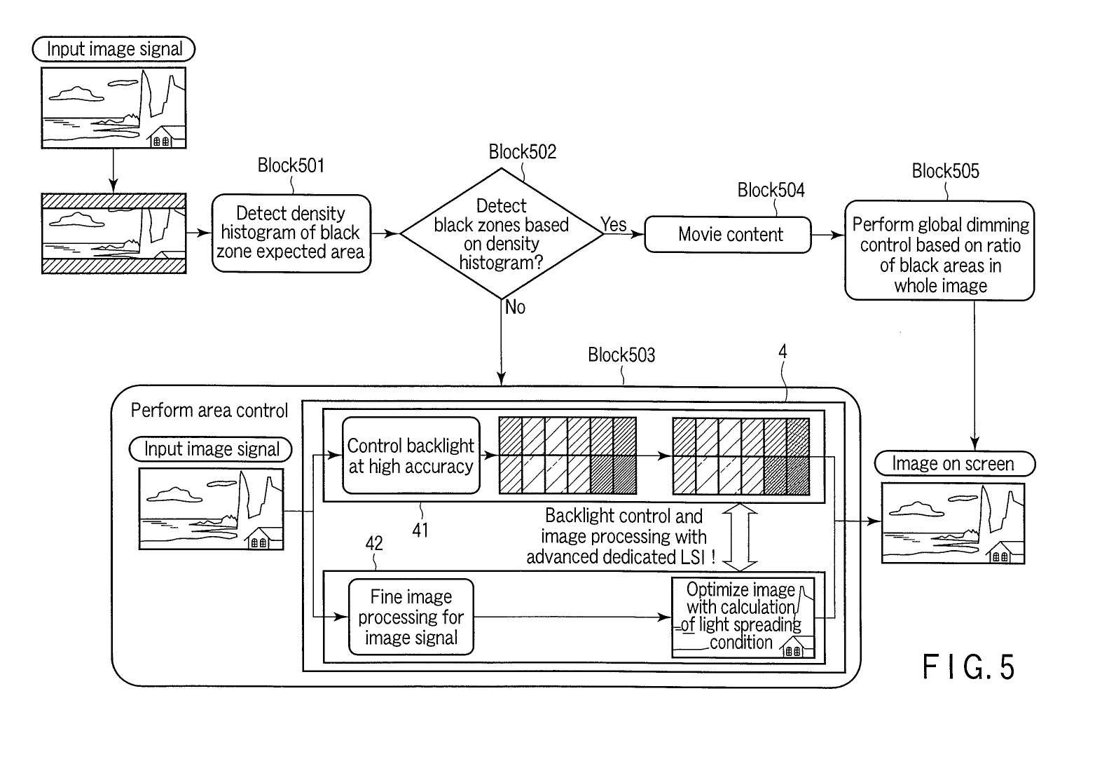

The first embodiment will be explained hereinafter with reference to FIG. 5. FIG. 5 is a diagram for explaining an example of luminance control according to the first embodiment.

When an image corresponding to an input image signal includes black zones, the black zones are arranged in upper and lower parts of the image. Specifically, positions of the black zones can be estimated to certain degree. For example, the image analysis module 3 generates a density histogram of black-zone-expected areas (zone areas located in upper and lower parts of the image) based on the input image signal (Block 501), and detects whether the image based on the input image signal includes black zones or not, based on the density histogram (Block 502). The image analysis module 3 can also generate a density histogram based on the input image signal, without consideration of the black-zone-expected areas, and detect whether the image based on the input image signal includes black zones or not, based on the density histogram.

When the image does not include black zones (Block 502, No), the luminance control module 41 performs area luminance control, based on a detection result indicating no black zones from the image analysis module 3 (Block 503). Specifically, the luminance control module 41 controls the luminances of the light sources of the backlight 61 based on the area luminance control signal. As another example, the luminance control module 41 sets the percentage of area luminance control higher than the percentage of whole luminance control, and uses area luminance control together with whole luminance control, based on the detection result indicating no black zones from the image analysis module 3. Specifically, the luminance control module 41 generates an area luminance control signal for area luminance control in accordance with the input image signal, generates a whole luminance control signal for whole luminance control in accordance with the input image signal, generates a correction luminance control signal to set the percentage of luminance control by the area luminance control signal higher than the percentage of luminance control by the whole luminance control signal, and controls the luminances of the light sources of the backlight 61 based on the correction luminance control signal. Thereby, for example, luminances of the light sources are controlled, strongly dependent on the average luminance of each partial image displayed in each of divided display areas 6201 to 6212, and luminances of the light sources are controlled, weakly dependent on the average luminance of the whole image displayed on the whole image display area. For example, when the average luminance of a partial image becomes high, the luminances of the light sources of the divided display area corresponding to the partial image are controlled to high luminance. However, even when the average luminance of the whole image greatly changes, the luminance change quantities of the light sources corresponding to the whole image are suppressed to small quantity.

When the image does not include black zones, the image (black zones) is not unnaturally displayed by area luminance control. Therefore, when the image does not include black zones, the effect of area luminance control is increased, the effect of whole luminance control is reduced, and thereby image quality can be increased by giving luminance control suitable for the image signal priority.

In addition, when the image includes black zones (Block 502, Yes), the luminance control module 41 determines that the image is movie content based on a detection result obtained from the image analysis module 3 and indicating that the image includes black zones (Block 504), and performs whole luminance control (Block 505). Specifically, the luminance control module 41 controls the luminances of the light sources of the backlight 61, based on a whole luminance control signal. As another example, the luminance control module 41 uses whole luminance control together with area luminance control, by setting the percentage of whole luminance control higher than the percentage of area luminance control, based on the detection result obtained from the image analysis module 3 and indicating that the image includes black zones. Specifically, the luminance control module 41 generates a whole luminance control signal for whole luminance control in accordance with the input image signal, generates an area luminance control signal for area luminance control in accordance with the input image signal, generates a correction luminance control signal to set the percentage of luminance control by the whole luminance control signal higher than the percentage of luminance control by the area luminance control signal, and controls luminances of the light sources of the backlight 61 based on the correction luminance control signal. Thereby, for example, luminances of the light sources are controlled, weakly dependent on the average luminance of each partial image displayed in each of divided display areas 6201 to 6212, and luminances of the light sources are controlled, strongly dependent on the average luminance of the whole image displayed on the whole image display area. For example, when the average luminance of the whole image becomes high, the luminances of the light sources corresponding to the whole image are controlled to high luminance. However, even when the average luminance of a partial image greatly changes, the luminance change quantities of the light sources of the divided display area corresponding to the partial image are suppressed to small quantity.

When the image includes black zones, there are cases where the image (black zones) is unnaturally displayed by area luminance control. Therefore, when the image includes black zones, the effect of area luminance control is reduced, the effect of whole luminance control is increased, and thereby luminance is controlled to suppress malfunctions, and decrease in image quality is prevented.

The luminance control module 41 can immediately change luminance control to area luminance control or whole luminance control based on the detection result indicating presence/absence of black zones, and immediately set the percentage of whole luminance control higher than the percentage of area luminance control. In addition, the luminance control module 41 can also gradually change the percentage of whole luminance control and the percentage of area luminance control, to set the ratio of whole luminance control to area luminance control to a target ratio.

### Second Embodiment

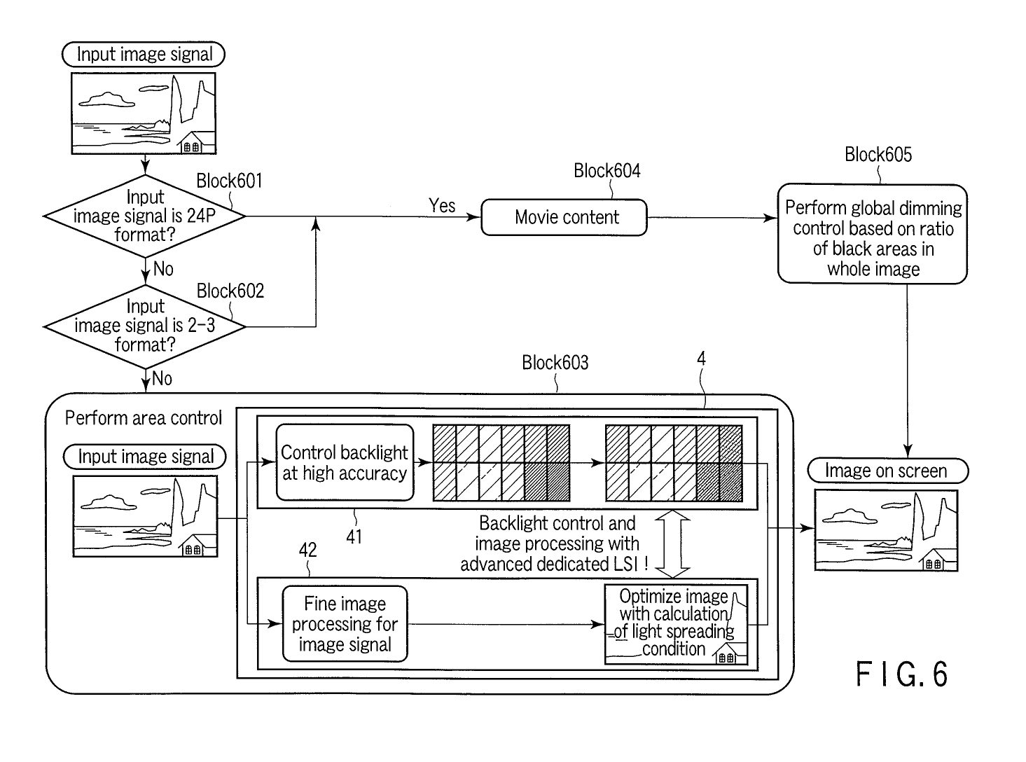

The second embodiment will be explained hereinafter with reference to FIG. 6. FIG. 6 is a diagram for explaining an example of luminance control according to the second embodiment.

When an image corresponding to an input image signal is movie content, the image format of the input image signal is, for example, 24P format or 2-3 pull-down format. The image analysis module 3 can detect the image format of the input image signal. When the image analysis module 3 detects that the image format of the input image signal is not 24P format or 2-3 pull-down format (Block 601, No) (Block 602, No), the luminance control module 41 performs area luminance control (Block 603). Specifically, the luminance control module 41 controls luminances of the light sources of the backlight 61, based on an area luminance control signal. As another example, the luminance control module 41 uses area luminance control together with whole luminance control, by setting the percentage of area luminance control higher than the percentage of whole luminance control. Specifically, the luminance control module 41 generates an area luminance control signal for area luminance control in accordance with the input image signal, generates a whole luminance control signal for whole luminance control in accordance with the input image signal, generates a correction luminance control signal to set the percentage of luminance control by the area luminance control signal higher than the percentage of luminance control by the whole luminance control signal, and controls the luminances of the light sources of the backlight 61 based on the correction luminance control signal.

When the image is not movie content, there is little possibility that the image includes black zones. Thus, the image (black zones) is not unnaturally displayed by area luminance control. Therefore, when the image is not movie content, the effect of area luminance control is increased, the effect of whole luminance control is reduced, and thereby image quality can be increased by giving luminance control suitable for the image signal priority.

In addition, when the image format of the input image signal is 24P format or 2-3 pull-down format (Block 601, Yes) (Block 603, Yes), the luminance control module 41 determines that the input image signal is movie content (Block 604), and performs whole luminance control (Block 605). Specifically, the luminance control module 41 controls luminances of the light sources of the backlight 61, based on a whole luminance control signal. As another example, the luminance control module 41 uses whole luminance control together with area luminance control, by setting the percentage of whole luminance control higher than the percentage of area luminance control. Specifically, the luminance control module 41 generates a whole luminance control signal for whole luminance control in accordance with the input image signal, generates an area luminance control signal for area luminance control in accordance with the input image signal, generates a correction luminance control signal to set the percentage of luminance control by the whole luminance control signal higher than the percentage of luminance control by the area luminance control signal, and controls the luminances of the light sources of the backlight 61 based on the correction luminance control signal.

When the image is movie content, there is high possibility that the image includes black zones. Thus, there are cases where the image (black zones) is unnaturally displayed by area luminance control. Therefore, when the image is movie content, the effect of whole luminance control is increased, the effect of area luminance control is reduced, and thereby luminance is controlled to suppress malfunctions, and decrease in image quality is prevented.

The luminance control module 41 can immediately change luminance control to area luminance control or whole luminance control based on the detection result of the image format, and immediately set the percentage of whole luminance control higher than the percentage of area luminance control. In addition, the luminance control module 41 can also gradually change the percentage of whole luminance control and the percentage of area luminance control, to set the ratio of whole luminance control to area luminance control to a target ratio.

### Third Embodiment

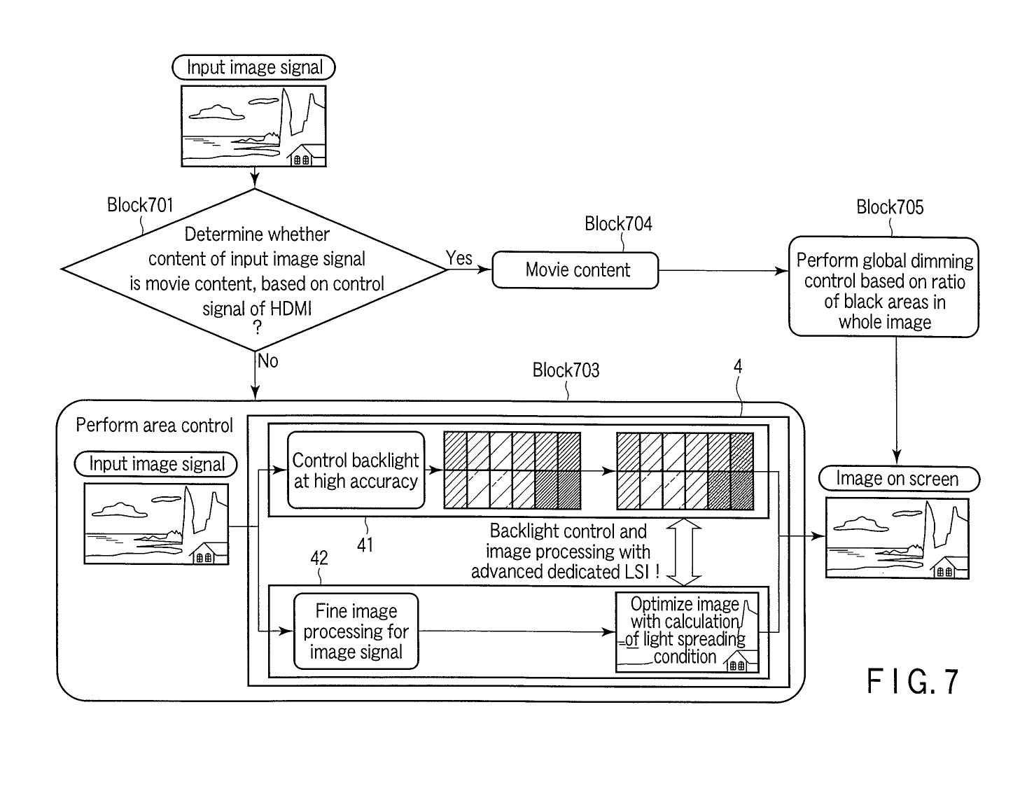

The third embodiment will be described hereinafter with reference to FIG. 7. FIG. 7 is a diagram for explaining an example of luminance control according to the third embodiment.

When the image display apparatus illustrated in FIG. 1 is connected to an image playback apparatus through an HDMI, the image display apparatus can detect the type of an input image signal, based on a control signal provided together with the image signal through the HDMI. When a main control module 2 determines that the type of the input image signal is other than movie content based on the control signal of the HDMI (Block 701, No), a luminance control module 41 performs area luminance control, based on a determination result of non-movie content (Block 703). Specifically, the luminance control module 41 controls luminances of the light sources of a backlight 61 based on an area luminance control signal. As another example, the luminance control module 41 uses area luminance control together with whole luminance control, by setting the percentage of area luminance control higher than the percentage of whole luminance control. Specifically, the luminance control module 41 generates an area luminance control signal for area luminance control in accordance with the input image signal, generates a whole luminance control signal for whole luminance control in accordance with the input image signal, generates a correction luminance control signal to set the percentage of luminance control by the area luminance control signal higher than the percentage of luminance control by the whole luminance control signal, and controls the luminances of the light sources of the backlight 61 based on the correction luminance control signal.

When the image is not movie content, there is little possibility that the image includes black zones. Thus, the image (black zones) is not unnaturally displayed by area luminance control. Therefore, when the image is not movie content, the effect of area luminance control is increased, the effect of whole luminance control is reduced, and thereby image quality can be increased by giving luminance control suitable for the image signal priority.

When the main control module 2 determines that the type of the input image signal is movie content based on the control signal of the HDMI (Block 701, No), the luminance control module 41 performs whole luminance control, based on a determination result of movie content (Block 704) (Block 705). Specifically, the luminance control module 41 controls luminances of the light sources of the backlight 61, based on a whole luminance control signal. As another example, the luminance control module 41 uses whole luminance control together with area luminance control, by setting the percentage of whole luminance control higher than the percentage of area luminance control. Specifically, the luminance control module 41 generates a whole luminance control signal for whole luminance control in accordance with the input image signal, generates an area luminance control signal for area luminance control in accordance with the input image signal, generates a correction luminance control signal to set the percentage of luminance control by the whole luminance control signal higher than the percentage of luminance control by the area luminance control signal, and controls the luminances of the light sources of the backlight 61 based on the correction luminance control signal.

When the image is movie content, there is high possibility that the image includes black zones. Thus, there are cases where the image (black zones) is unnaturally displayed by area luminance control. Therefore, when the image is movie content, the effect of whole luminance control is increased, the effect of area luminance control is reduced, and thereby luminance is controlled to suppress malfunctions, and decrease in image quality is prevented.

The luminance control module 41 can immediately change luminance control to area luminance control or whole luminance control based on a detection result of movie content, and immediately set the percentage of whole luminance control higher than the percentage of area luminance control. In addition, the luminance control module 41 can also gradually change the percentage of whole luminance control and the percentage of area luminance control, to set the ratio of whole luminance control to area luminance control to a target ratio.

### Fourth Embodiment

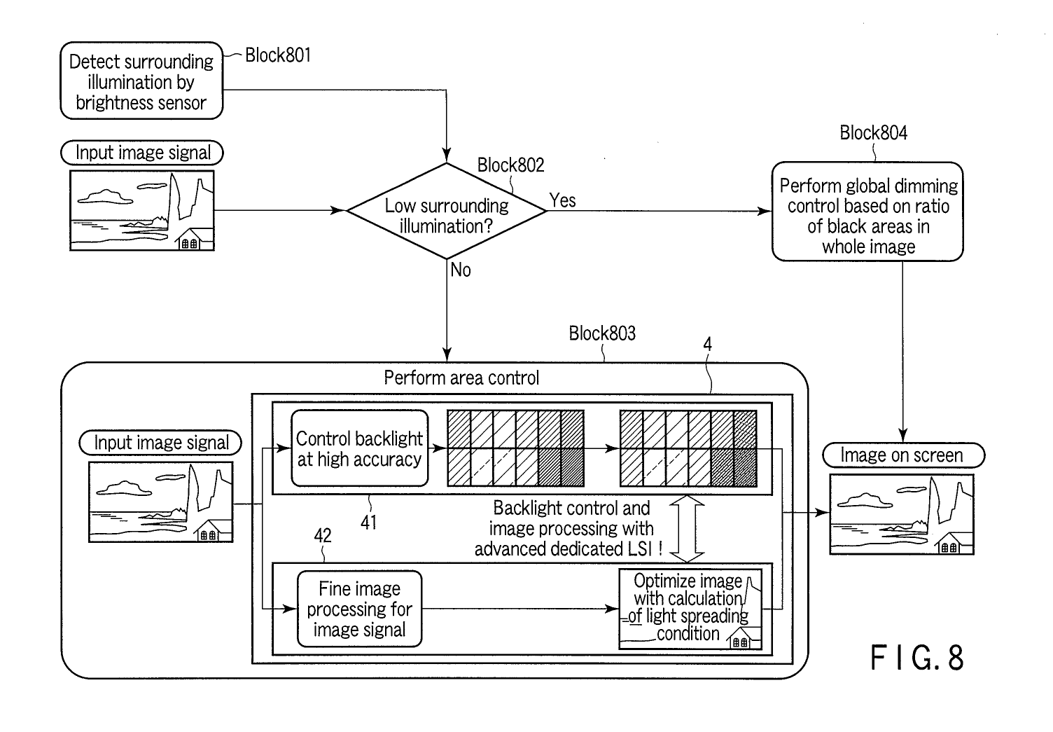

The fourth embodiment will be described hereinafter with reference to FIG. 8. FIG. 8 is a diagram for explaining an example of luminance control according to the fourth embodiment.

The image display apparatus illustrated in FIG. 1 includes a brightness sensor 7, and the brightness sensor 7 can detect, for example, illumination around the display module 7 (Block 801). When a main control module 2 determines that the surrounding illumination is high (Block 802, No), a luminance control module 41 performs area luminance control, based on a surrounding illumination determination result (high) (Block 803). Specifically, the luminance control module 41 controls luminances of light sources of a backlight 61 based on an area luminance control signal. As another example, the luminance control module 41 uses area luminance control together with whole luminance control, by setting the percentage of area luminance control higher than the percentage of whole luminance control. Specifically, the luminance control module 41 generates an area luminance control signal for area luminance control in accordance with the input image signal, generates a whole luminance control signal for whole luminance control in accordance with the input image signal, generates a correction luminance control signal to set the percentage of luminance control by the area luminance control signal higher than the percentage of luminance control by the whole luminance control signal, and controls the luminances of the light sources of the backlight 61 based on the correction luminance control signal. Thereby, for example, the image display apparatus can control luminance for each divided display area by area luminance control based on the input image signal, while the whole luminance of the backlight 61 is increased by whole luminance control, based on the surrounding illumination determination result (high).

When the surrounding illumination value is high (when the environment is light), even if the image includes black zones and luminance of the black zones is not uniform by area luminance control, change in luminance of the black zones is not easily recognized with human eyes. Therefore, even when luminance of the black zones is not uniform due to area luminance control, it is inconspicuous. Thus, when the surrounding illumination value is high (when the environment is light), the effect of area luminance control is increased, the effect of whole luminance control is reduced, and thereby image quality can be increased by giving luminance control suitable for the image signal priority.

When the main control module 2 determines that the surrounding illumination is low based on the surrounding illumination detection value from the brightness sensor 7 (for example, a low surrounding illumination detection value which is lower than a reference surrounding illumination value) (Block 802, Yes), the luminance control module 41 performs whole luminance control, based on a surrounding illumination determination result (low) (Block 804). Specifically, the luminance control module 41 controls luminances of the light sources of the backlight 61, based on a whole luminance control signal. As another example, the luminance control module 41 uses whole luminance control together with area luminance control, by setting the percentage of whole luminance control higher than the percentage of area luminance control. Specifically, the luminance control module 41 generates a whole luminance control signal for whole luminance control in accordance with the input image signal, generates an area luminance control signal for area luminance control in accordance with the input image signal, generates a correction luminance control signal to set the percentage of luminance control by the whole luminance control signal higher than the percentage of luminance control by the area luminance control signal, and controls the luminances of the light sources of the backlight 61 based on the correction luminance control signal. Thereby, for example, the image display apparatus can control luminance for each divided display area by area luminance control based on the input image signal, while the whole luminance of the backlight 61 is decreased by whole luminance control, based on the surrounding illumination determination result (low).

When the surrounding illumination value is low (when the environment is dark), when the image includes black zones and luminance of the black zones becomes non-uniform due to area luminance control, change in luminance of the black zones is easily recognized with human eyes. Therefore, when luminance of the black zones becomes non-uniform due to area luminance control, it is conspicuous. Thus, when the surrounding illumination value is low (when the environment is dark), the effect of whole luminance control is increased, the effect of area luminance control is reduced, and thereby decrease in image quality can be prevented by controlling the luminance to suppress non-uniformity of luminance of the black zones.

The luminance control module 41 can immediately change luminance control to area luminance control or whole luminance control based on the surrounding illumination detection value, and immediately set the percentage of whole luminance control higher than the percentage of area luminance control, or immediately set the percentage of area luminance control higher than the percentage of whole luminance control. In addition, the luminance control module 41 can also gradually change the percentage of whole luminance control and the percentage of area luminance control, to set the ratio of whole luminance control to area luminance control to a target ratio.

The image display apparatuses of the above first to fourth embodiments can control luminance of the backlight only by whole luminance control, control luminance of the backlight only by area luminance control, and use whole luminance control together with area luminance control, in accordance with various conditions (characteristic of the input image signal or environmental conditions). For example, using whole luminance control together with area luminance control means changing the ratio of whole luminance control to area luminance control.

Thereby, according to the image display apparatuses of the above first to fourth embodiment, it is possible to prevent the image from being unnatural, under the conditions in which the image becomes unnatural when luminance of the backlight is controlled only by area luminance control. In addition, electric power consumption increases when luminance of the backlight is controlled only by whole luminance control, under the conditions in which the image becomes unnatural when luminance of the backlight is controlled only by area luminance control. In comparison with this, the image display apparatuses of the above first to fourth embodiments can use whole luminance control together with area luminance control, and thereby prevent the image from being unnatural, while electric power consumption is suppressed.

According to the first to fourth embodiments, it is possible to provide an image display apparatus (light source luminance control apparatus) and an image display method (light source luminance controlling method) which can provide excellent light source luminance control.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light source luminance control apparatus comprising:
a generator, in which a light source block formed of one or more light sources corresponds to a divided display area, and an image display area formed of a plurality of divided display areas corresponds to a plurality of light source blocks, the generator being configured to generate a first luminance control signal to perform whole control of luminances of the light sources corresponding to the image display area, in accordance with an image signal, and generate a second luminance control signal to perform divided control of luminance of each light source for each of the light source blocks, in accordance with the image signal; and
a luminance controller configured to control the luminances of the light sources, based on the first and the second luminance control signals.

2. The apparatus of claim 1, wherein
the luminance controller is configured to perform variable control of a percentage of the whole control and a percentage of the divided control, in accordance with the image signal.

3. The apparatus of claim 2, wherein
the luminance controller is configured to set the percentage of the whole control higher than the percentage of the divided control, in accordance with detection of a black zone based on the image signal.

4. The apparatus of claim 2, wherein
the luminance controller is configured to set the percentage of the whole control higher than the percentage of the divided control, in accordance with detection of movie content based on the image signal.

5. The apparatus of claim 2, wherein
the luminance controller is configured to set the percentage of the whole control higher than the percentage of the divided control, in accordance with detection of movie content based on a control signal provided together with the image signal.

6. The apparatus of claim 1, wherein
the luminance controller is configured to perform variable control of a percentage of the whole control and a percentage of the divided control, in accordance with surrounding illumination.

7. The apparatus of claim 6, wherein
the luminance controller is configured to set the percentage of the whole control higher than the percentage of the divided control, in accordance with detection of a low surrounding illumination value which is lower than a reference surrounding illumination value.

8. A light source luminance controlling method comprising:
generating, in which a light source block formed of one or more light sources corresponds to a divided display area, and an image display area formed of a plurality of divided display areas corresponds to a plurality of light source blocks, a first luminance control signal to perform whole control of luminances of the light sources corresponding to the image display area, in accordance with an image signal, and generate a second luminance control signal to perform divided control of luminance of each light source for each of the light source blocks, in accordance with the image signal; and
controlling the luminances of the light sources, based on the first and the second luminance control signals.
